(19) United States
(12) Patent Application Publication
(10) Pub. No.: US 2025/0227019 A1
(43) Pub. Date: Jul. 10, 2025

(54) NETWORK MONITORING SYSTEM, NETWORK MONITORING METHOD, AND RECORDING MEDIUM

(71) Applicant: NEC CORPORATION, Minato-ku, Tokyo (JP)

(72) Inventors: Noboru NAGATANI, Tokyo (JP); Tomoo ADACHI, Tokyo (JP); Shuichi KARINO, Tokyo (JP)

(73) Assignee: NEC CORPORATION, Minato-ku, Tokyo (JP)

(21) Appl. No.: 18/850,152

(22) PCT Filed: Mar. 31, 2022
(86) PCT No.: PCT/JP2022/016398

§ 371 Date: Sep. 24, 2024

(51) Int. Cl. H04L 41/0631

(52) U.S. Cl. CPC H04L 41/0631

(57) ABSTRACT

A network monitoring system according to the present disclosure comprises a terminal server that is console-connected to a plurality of network devices, and a network management device that monitors console output information from the terminal server. The network management device comprises: a monitoring means that monitors whether or not abnormality information indicating abnormality in firmware is included in console output information items outputted from the network devices; and a notification means that, if abnormality information is included in any of the console output information items, identifies the network device that outputted the abnormality information and provides a notification.

### TECHNICAL FIELD

The present disclosure relates to a network monitoring system, a network monitoring method, and a recording medium.

### BACKGROUND ART

There is a technique of remotely monitoring occurrence of abnormality of a device by console output information.

For example, PTL 1 discloses a monitoring device that constantly monitors information output from an electronic computer to be displayed on a console, detects an abnormality from console output information, and notifies a monitoring center of occurrence of the abnormality.

### CITATION LIST

### Patent Literature

PTL 1: JP 5-282180 A

### SUMMARY OF INVENTION

### Technical Problem

However, the console is typically a serial interface and is typically not available for one-to-many communications. Therefore, the invention described in PTL 1 cannot be applied to a case where there are a plurality of management targets.

After a network device is activated, it may be possible to log in to the network device from a communication interface other than the console, retrieve a log of the network device, and detect an abnormality. However, in a case where the activation of the network device fails, the communication interface does not operate, and thus the log cannot be retrieved by the above-described method.

An object of the present disclosure is to provide a network monitoring system capable of remotely monitoring an abnormality at the time of activation of a plurality of network devices.

### Solution to Problem

A network monitoring system according to one aspect of the present disclosure includes: a terminal server that is console-connected to a plurality of network devices; and a network management device that monitors console output information from the terminal server. The network management device includes a monitoring means for monitoring whether abnormality information indicating an abnormality of firmware is included in each piece of console output information output from the network devices, and a notification means for, in a case where the abnormality information is included in any piece of the console output information, identifying the network device that has output the abnormality information and providing a notification.

A network monitoring method according to one aspect of the present disclosure causes a computer to: monitor whether abnormality information indicating an abnormality of firmware is included in each piece of console output information output from a plurality of network devices; and in a case where the abnormality information is included in any piece of the console output information, identify the network device that has output the abnormality information and provides a notification.

A recording medium according to one aspect of the present disclosure has stored therein a program for causing a computer to: monitor whether abnormality information indicating an abnormality of firmware is included in each piece of console output information output from a plurality of network devices; and in a case where the abnormality information is included in any piece of the console output information, identify the network device that has output the abnormality information and provides a notification.

### Advantageous Effects of Invention

An example of an effect of the present disclosure is to provide a network monitoring system capable of remotely monitoring an abnormality of a plurality of network devices.

### BRIEF DESCRIPTION OF DRAWINGS

FIG. 1 is a block diagram illustrating a configuration of a network monitoring system according to a first example embodiment.

FIG. 2 is a diagram illustrating a hardware configuration in which the network monitoring system according to the first example embodiment is achieved by a computer device and its peripheral devices.

FIG. 3 is a flowchart illustrating an operation of network monitoring in the first example embodiment.

FIG. 4 is a block diagram illustrating a configuration of a network monitoring system according to a second example embodiment.

FIG. 5 is a flowchart illustrating an operation of network monitoring in the second example embodiment.

### EXAMPLE EMBODIMENT

Next, an example embodiment will be described in detail with reference to the drawings.

### First Example Embodiment

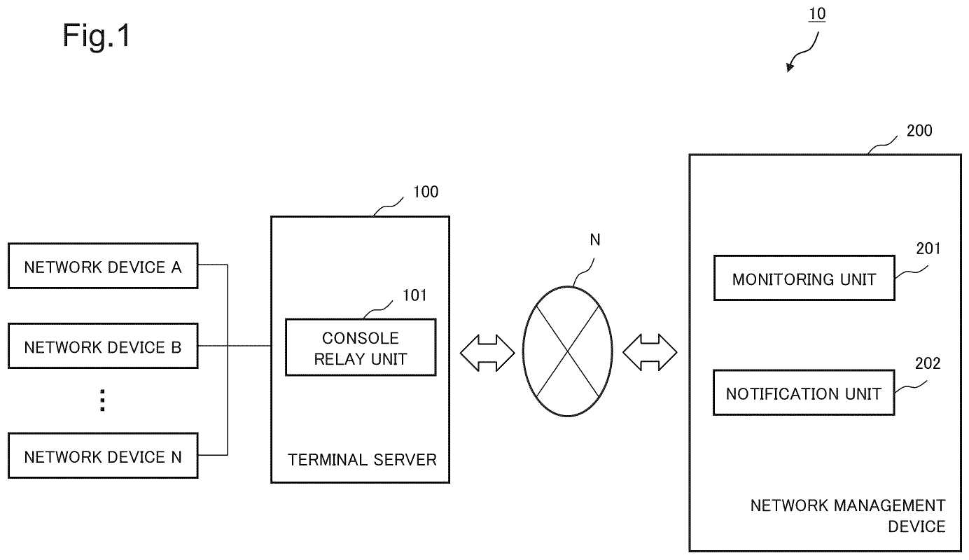

FIG. 1 is a block diagram illustrating a configuration of a network monitoring system 10 according to a first example embodiment. Referring to FIG. 1, the network monitoring system 10 includes a terminal server 100 that is console-connected to a plurality of network devices, and a network management device 200 that monitors information output from the terminal server 100. In the present example embodiment, the network device is a device, such as a router, a hub, a gateway, or a switch, for relaying or transferring data on a network, and is a device to be managed for monitoring an abnormality at the time of firmware activation. The network device includes a console port, and may output information such as an activation log even in a case where a communication interface other than the console port of the network device does not function. In FIG. 1, network devices A, B, . . . , N are connected to a business network (not illustrated).

The terminal server 100 in the present example embodiment is a network device that can be console-connected to a plurality of network devices at a time. The terminal server 100 is connected to the network management device 200 via a management network N. In the present example embodiment, the console-connection is to connect the network device and the terminal server 100 by connecting a console cable such as a serial cable to the console port of the network device. The terminal server 100 includes a console relay unit 101 that is console-connected to the console ports of the plurality of network devices by using console cables and relays, to the management network N, information (console output information) output from the console ports. By displaying the console output information on an output device such as a display, the administrator of the network device can grasp an abnormality or falsification of firmware or the like of each network device. In addition, even in a case where the network device is not activated and the communication interface other than the console port does not operate, the status of each network device can be grasped based on the console output information. In the present example embodiment, a configuration for monitoring a network device connected to a business network will be mainly described, but a configuration for monitoring a network device connected to the management network N may be adopted.

The console relay unit 101 may add, to the console output information, information for determining which network device outputs the console output information. Alternatively, the terminal server 100 may provide the business network with a function of switching a target network device from which the console output information is relayed. In addition, the terminal server 100 may have a function of accumulating the console output information that is not a relay target therein and transmitting the console output information of the network device when selected as the relay target.

In the present example embodiment, when the activation of any of the plurality of network devices fails, in a case where the cause of the failure is not an abnormality caused by a power supply or the like, log information indicating that the activation has failed is output to the console output information. In particular, in a case where an abnormality or falsification of firmware or the like is detected at the time of activation, the information regarding the abnormality is output to the console output information, and an operation that the firmware is not read is performed.

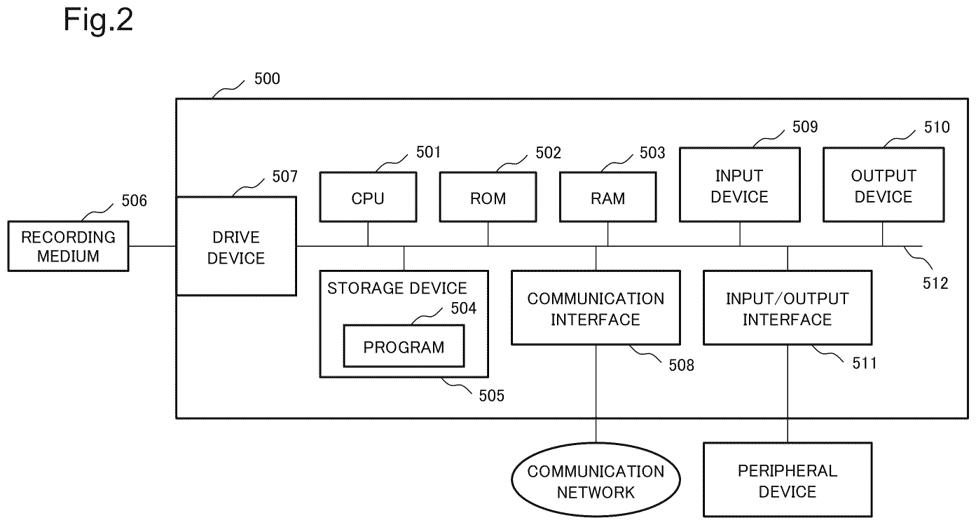

FIG. 2 is a diagram illustrating an example of a hardware configuration in which the network management device 200 according to the first example embodiment of the present disclosure is achieved by a computer device 500 including a processor. As illustrated in FIG. 2, the network management device 200 includes a memory such as a central processing unit (CPU) 501, a read only memory (ROM) 502, and a random access memory (RAM) 503, a storage device 505 such as a hard disk that stores a program 504, a communication interface 508 for network connection, and an input/output interface 511 that inputs and outputs data. In the first example embodiment, the console output information acquired by a monitoring unit 201 of the network management device 200 is input to the network management device 200 via the communication interface 508.

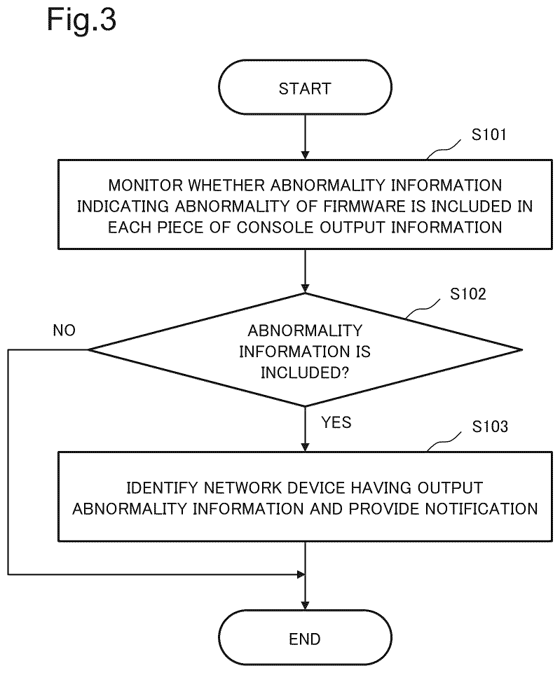

The CPU 501 operates an operating system to control the entire network management device 200 according to the first example embodiment of the present invention. In addition, the CPU 501 reads a program and data from a recording medium 506 attached to a drive device 507 or the like to a memory, for example. In addition, the CPU 501 functions as the monitoring unit 201, a notification unit 202, and a part thereof in the first example embodiment, and executes processing or a command in the flowchart illustrated in FIG. 3 to be described later, based on a program.

The recording medium 506 is, for example, an optical disk, a flexible disk, a magnetic optical disk, an external hard disk, a semiconductor memory, or the like. A part of the recording medium of the storage device is a non-volatile storage device, and records a program therein. In addition, the program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to confirm an output.

As described above, the first example embodiment illustrated in FIG. 1 is achieved by the computer hardware illustrated in FIG. 2. However, the means for achieving each unit included in the network management device 200 in FIG. 1 is not limited to the above-described configuration. In addition, the network management device 200 may be achieved by one physically coupled device, or may be achieved by a plurality of devices in which two or more physically separated devices are connected in a wired or wireless manner. For example, the input device 509 and the output device 510 may be connected to the computer device 500 via a network. In addition, the network management device 200 according to the first example embodiment illustrated in FIG. 1 can also be configured by cloud computing or the like.

In FIG. 1, the monitoring unit 201 is a means that monitors whether abnormality information indicating an abnormality of firmware is included in each piece of console output information output from the plurality of network devices. The monitoring unit 201 detects an abnormality of firmware by monitoring whether each pieces of console output information includes, for example, a character string indicating that the activation has failed. In the case of having detected an abnormality of firmware, the monitoring unit 201 outputs, to the notification unit 202, information for identifying the network device for which the abnormality is detected.

The notification unit 202 is a means that, in a case where abnormality information is included in any piece of the console output information, identifies the network device that has output the abnormality information and provides a notification. When the information for identifying the network device that has output the abnormality information is input from the monitoring unit 201, the notification unit 202 outputs the name of the network device or the like to the output device 510 or the like to notify the administrator.

An operation of the network monitoring system 10 configured as described above will be described with reference to a flowchart of FIG. 3.

FIG. 3 is a flowchart illustrating an outline of the operation of the network monitoring system 10 according to the first example embodiment. Note that the processing according to this flowchart may be executed based on program control by the processor described above.

As illustrated in FIG. 3, first, the monitoring unit 201 monitors whether abnormality information indicating an abnormality of firmware is included in each piece of console output information output from a plurality of network devices (step S101). Next, in the monitoring unit 201, if the abnormality information is included in any piece of the console output information (step S102; YES), the notification unit 202 identifies the network device that has output the abnormality information and provides a notification (step S103). On the other hand, if the abnormality information is not included in any piece of the console output information (step S102; NO), the monitoring unit 201 ends the processing. The network monitoring system 10 repeats the processing according to this flowchart every time any one of the network devices is activated. With the above, the network monitoring system 10 ends the operation.

In the network monitoring system 10 according to the first example embodiment, in a case where the abnormality information indicating the abnormality of firmware is included in the console output information of any of the network devices, the notification unit 202 identifies the network device that has output the abnormality information and provides a notification. Accordingly, it is possible to remotely monitor an abnormality at the time of activation of the plurality of network devices.

### Second Example Embodiment

Next, a second example embodiment of the present disclosure will be described in detail with reference to the drawings. Hereinafter, description of contents overlapping with the above description will be omitted to the extent that the description of the present example embodiment is not unclear.

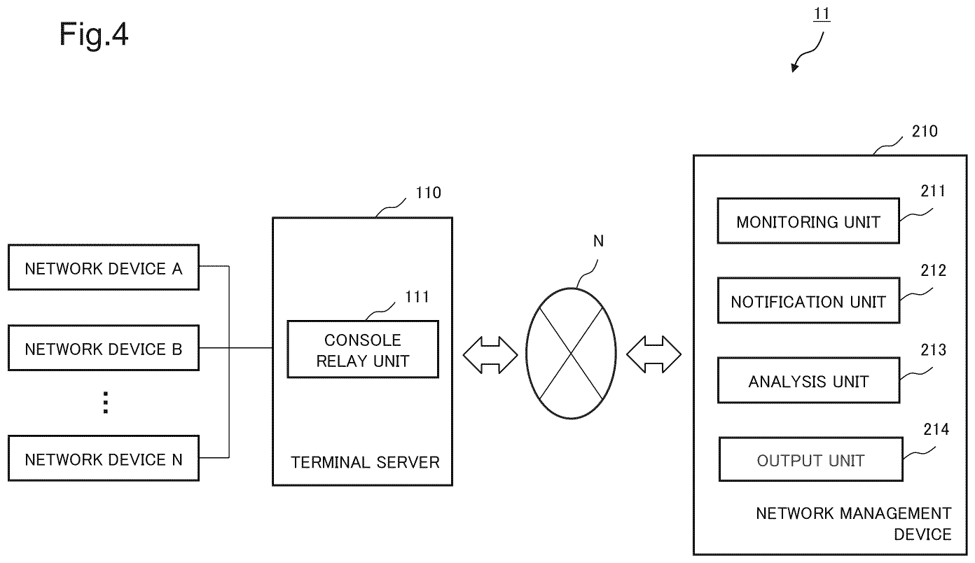

FIG. 4 is a block diagram illustrating a configuration of a network monitoring system 11 according to the second example embodiment of the present disclosure. With reference to FIG. 4, the network monitoring system 11 according to the second example embodiment will be described focusing on portions different from those of the network monitoring system 10 according to the first example embodiment. In the network monitoring system 11 according to the second example embodiment, a network management device 210 includes a monitoring unit 211, a notification unit 212, an analysis unit 213, and an output unit 214. Since the monitoring unit 211 and the notification unit 212 are similar to the monitoring unit 201 and the notification unit 202 of the first example embodiment, the description thereof will be omitted.

The analysis unit 213 is a means that, in a case where abnormality information is included in any piece of the console output information, analyzes a location indicating an abnormality cause in the console output information. The location indicating the abnormality cause is, for example, a location indicating a reason why the network device has not read or executed firmware. When the monitoring unit 211 detects an abnormality in the firmware, the analysis unit 213 analyzes the location indicating the abnormality cause. In a case where the location indicating the abnormality cause is a character string, the analysis unit 213 analyzes the abnormality cause by collating with a character string to be collated held in advance. Examples of the character string to be collated include a character string indicating that the electronic signature of the firmware does not match.

In a case where the location indicating the abnormality cause is a measurement value, the analysis unit 213 extracts the measurement value. The measurement value is a value obtained by calculating states of a network device, a program, and data or configurations thereof with characters and numerical values at the time of activation of the network device, and is, for example, a hash value of firmware. For example, in order to extract the description location of the measurement value in the console output information, the network monitoring system 11 holds, in the storage device 505, character strings that appear before and after the measurement value. The analysis unit 213 collates the same character string with the console output information, determines the position of the measurement value, and extracts the measurement value. Note that, in a case where a normal measurement value is held in advance in the storage device 505, the analysis unit 213 may collate the normal value with the measurement value. In a case where the measurement value in the console output information is abnormal, for example, if the measurement value is a hash value of firmware, falsification of the firmware can be detected. In addition, if the measurement value is other than the hash value of firmware, for example, it is also possible to detect that a portion other than the firmware, such as a setting file of the network device, has been falsified at the time of activation or the like due to an abnormality (such as replacing some components) in the main body of the network device.

The output unit 214 is a means that outputs an analysis result by the analysis unit 213 to the output device 510 or the like. The output unit 214 outputs the abnormality cause in a case where the location indicating the abnormality cause is a character string. For example, in a case where the electronic signature of the firmware does not match, the output unit 214 outputs an analysis result indicating that the electronic signature does not match. In a case where the location indicating the abnormality cause is a measurement value, the output unit 214 outputs the extracted measurement value. In a case where the normal value and the measurement value are collated, the output unit 214 may output the collated result.

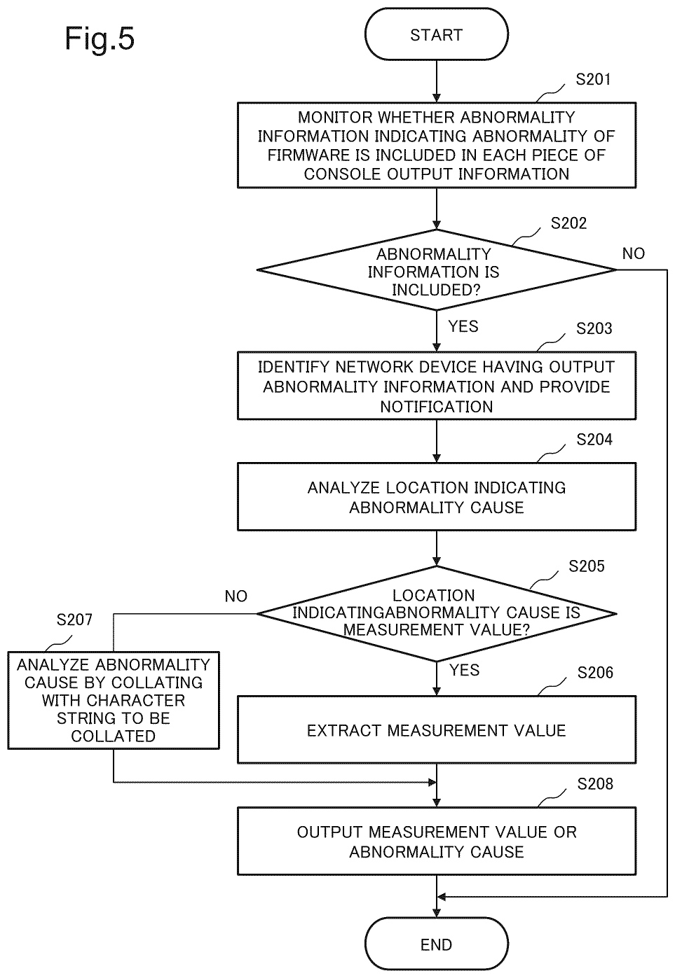

An operation of the network monitoring system 11 configured as described above will be described with reference to a flowchart of FIG. 5.

FIG. 5 is a flowchart illustrating an outline of the operation of the network monitoring system 11 according to the second example embodiment. Note that the processing according to this flowchart may be executed based on program control by the processor described above.

As illustrated in FIG. 5, first, the monitoring unit 211 monitors whether abnormality information indicating an abnormality of firmware is included in each piece of console output information output from a plurality of network devices (step S201). Next, in the monitoring unit 211, if the abnormality information is included in any piece of the console output information (step S202; YES), the notification unit 212 identifies the network device that has output the abnormality information and provides a notification (step S203). On the other hand, if the abnormality information is not included in any piece of the console output information (step S202; NO) the monitoring unit 211 ends the processing. Next, the analysis unit 213 analyzes the location indicating the abnormality cause in the console output information (step S204). If the location indicating the abnormality cause is a measurement value (step S205; YES), the analysis unit 213 extracts the measurement value (step S206). If the location indicating the abnormality cause is a character string (step S205; NO), the analysis unit 213 analyzes the abnormality cause by collating with a character string to be collated (step S207). Finally, the output unit 214 outputs the extracted measurement value or abnormality cause. With the above, the network monitoring system 11 ends the operation.

In the network monitoring system 11 according to the second example embodiment of the present disclosure, the analysis unit 213 analyzes a location indicating the abnormality cause, based on the console output information. Accordingly, the administrator can grasp the cause of the abnormality of the network device.

While the present invention has been described with reference to each example embodiment, the present invention is not limited to the above-described example embodiments. It will be understood by those of ordinary skill in the art that various changes in form and details may be made therein without departing from the spirit and scope of the present invention as defined by the claims.

For example, although a plurality of operations are described in order in the form of a flowchart, the order of description does not limit the order of executing the plurality of operations. Therefore, when each example embodiment is implemented, the order of the plurality of operations can be changed within a range that does not interfere with the content.

### REFERENCE SIGNS LIST

10, 11 network monitoring system
100, 110 terminal server
200, 210 network management device
201, 211 monitoring unit
202, 212 notification unit
213 analysis unit
214 output unit

What is claimed is:

1. A network monitoring system comprising:
a terminal server that is console-connected to a plurality of network devices; and
a network management device that monitors console output information from the terminal server, wherein
the network management device includes comprising:
a memory storing instructions; and
at least one processor configured to execute the instructions to:
monitor whether abnormality information indicating an abnormality of firmware is included in each piece of console output information output from the network devices, and
in a case where the abnormality information is included in any piece of the console output information, identify the network device that has output the abnormality information and providing a notification.

2. The network monitoring system according to claim 1, wherein the at least one processor is further configured to execute the instructions to:
in a case where the abnormality information is included in any piece of the console output information, analyze a location indicating an abnormality cause in the console output information, and
output an analysis result of the location indicating the abnormality cause.

3. The network monitoring system according to claim 2, wherein the at least one processor is further configured to execute the instructions to:
in a case where the location indicating the abnormality cause is a character string, analyze the abnormality cause by collating with a character string to be collated held in advance, and
output the abnormality cause.

4. The network monitoring system according to claim 2, wherein the at least one processor is further configured to execute the instructions to:
in a case where the location indicating the abnormality cause is a measurement value, extract the measurement value, and
output the extracted measurement value.

5. A network monitoring method for causing a computer to:
the step of monitoring monitor whether abnormality information indicating an abnormality of firmware is included in each piece of console output information output from a plurality of network devices; and
the step of identifying the network device that has output the abnormality information and provides a notification in a case where the abnormality information is included in any piece of the console output information.

6. A non-transitory recording medium having stored therein a program for causing a computer to:
the step of monitoring whether abnormality information indicating an abnormality of firmware is included in each piece of console output information output from a plurality of network devices; and
the step of identifying identify the network device that has output the abnormality information and provides a notification in a case where the abnormality information is included in any piece of the console output information.

7. A network monitoring method according to claim 5, further comprising:
the step of analyzing a location indicating an abnormality cause in the console output information in a case where the abnormality information is included in any piece of the console output information; and
the step of outputting an analysis result of the location indicating the abnormality cause.

8. The network monitoring system according to claim 7, wherein further comprising:
the step of analyzing the abnormality cause by collating with a character string to be collated held in advance in a case where the location indicating the abnormality cause is a character string; and
the step of outputting the abnormality cause.

9. The network monitoring system according to claim 7, wherein further comprising:
the step of extracting the measurement value in a case where the location indicating the abnormality cause is a measurement value; and
the step of outputting the extracted measurement value.

10. The recording medium according to claim 6, further comprising:
the step of analyzing a location indicating an abnormality cause in the console output information in a case where the abnormality information is included in any piece of the console output information; and
the step of outputting an analysis result of the location indicating the abnormality cause.

11. The recording medium according to claim 10, wherein further comprising:
the step of analyzing the abnormality cause by collating with a character string to be collated held in advance in a case where the location indicating the abnormality cause is a character string; and
the step of outputting the abnormality cause.

12. The recording medium according to claim 10, wherein further comprising: the step of extracting the measurement value in a case where the location indicating the abnormality cause is a measurement value; and
the step of outputting the extracted measurement value.
